(19) United States
(12) Patent Application Publication
(10) Pub. No.: US 2026/0087704 A1
(43) Pub. Date: Mar. 26, 2026

(54) METHOD FOR PROVIDING TRADITIONAL MAKE-UP SERVICE

(71) Applicant: Keejung BARNG, Pyeongtaek-si (KR)

(72) Inventor: Keejung BARNG, Pyeongtaek-si (KR)

(21) Appl. No.: 19/325,444

(22) Filed: Sep. 10, 2025

(30) Foreign Application Priority Data
Sep. 23, 2024 (KR) 10-2024-0128043

(51) Int. Cl. G06T 11/60; G06Q 30/0601; G06T 7/13; G06T 7/90

(52) U.S. Cl. CPC G06T 11/60; G06Q 30/06431; G06T 7/13; G06T 7/90; G06T 2207/10024; G06T 2207/30201

(57) ABSTRACT

A method for providing a traditional make-up service, includes displaying, by an electronic device, a plurality of standard person images with traditional make-up; displaying, by the electronic device, a user's facial image; displaying, by the electronic device, a standard person image having a high correlation with a result of analyzing the user's facial image among the plurality of standard person images based on the analysis of the user's facial image; and displaying, by the electronic device, the user's facial image with virtual make-up by user-customized make-up data based on the make-up reference data of the standard person image having the high correlation and the result of analyzing the user's facial image.

### CROSS-REFERENCE TO RELATED APPLICATION

This application claims the benefit of Korean Patent Application No. 10-2024-0128043 filed on Sep. 23, 2024, in the Korean Intellectual Property Office, the entire disclosure of which is incorporated herein by reference for all purposes.

### BACKGROUND OF THE INVENTION

The present disclosure relates to a method for providing a traditional make-up service.

The make-up related market continues to grow as individuals' interest in various personalities and beauty is respected.

In particular, with the growth of video sharing platforms such as SNS and YouTube or short-form provision platforms such as TikTok, the spread of make-up methods and cosmetics is taking place almost in real time.

However, interest in traditional make-up is relatively low, so demand for services that allow traditional make-up to be enjoyed online is increasing.

### SUMMARY OF THE INVENTION

A method for providing a traditional make-up service according to an embodiment of the present disclosure aims to provide information related to traditional make-up online.

The problems herein are not limited to the above-mentioned problems, and other problems that are not mentioned herein will be clearly understood by those skilled in the art from the description below.

According an aspect of the present disclosure, there is provided a method for providing a traditional make-up service, the method including displaying, by an electronic device, a plurality of standard person images with traditional make-up; displaying, by the electronic device, a user's facial image; displaying, by the electronic device, a standard person image having a high correlation with a result of analyzing the user's facial image among the plurality of standard person images based on the analysis of the user's facial image; and displaying, by the electronic device, the user's facial image with virtual make-up by user-customized make-up data based on the make-up reference data of the standard person image having the high correlation and the result of analyzing the user's facial image.

The user-customized make-up data may include recipe information of user-customized cosmetic materials.

The recipe information of the user-customized cosmetic materials may correspond to a result of adding or reducing at least some of the ingredients of the make-up reference data based on the result of analyzing the user's facial image.

The result of analyzing the user's facial image may include a skin color tone, wherein the recipe of the user-customized cosmetic materials adds or reduces at least some of the ingredients of the make-up reference data according to the user's skin color tone.

The electronic device may display information on selling and delivering cosmetics according to a recipe of the user-customized cosmetic materials.

The analysis of the user's facial image may include the user's facial contour, and the facial reference data of each of the plurality of standard person images may include a facial contour, a gache, and a hair ornament of each standard person, wherein the electronic device displays the gache and hair ornament included in the facial reference data of a standard person image having a high correlation with the user's facial contour by adding to the user's facial image.

The electronic device may adjust and display a size of the gache included in the facial reference data according to the user's facial size.

The standard person image may be a portrait of a woman from the Joseon Dynasty or a photo of a standard person with traditional make-up according to the portrait of the woman from the Joseon Dynasty.

According to another aspect of the present disclosure, there is provided a method for providing a traditional make-up service, the method including displaying, by an electronic device, a plurality of standard person images with traditional make-up for eyebrows; displaying, by the electronic device, a user's facial image; selecting and displaying, by the electronic device, a standard person image having an eyebrow shape highly correlated with the user's eyebrow shape from among a plurality of standard person images according to an analysis of eyebrows on the user's facial image; and adjusting, by the electronic device, the eyebrow make-up reference data of the standard person image having a high correlation according to an eye size of the user's facial image to apply the data to eyebrow make-up on the user's facial image.

The plurality of standard person images may include ten eyebrow make-up shapes according to the Sibmiyo, the eyebrow make-up reference data may include a reference eyebrow length, a reference eyebrow height, and a reference eyebrow tail length of each of the ten eyebrow make-up shapes, and the electronic device may adjust the reference eyebrow length, the reference eyebrow height, and the reference eyebrow tail length of the selected standard person image according to the user's eye length and pupil size.

One of the ten eyebrow make-up shapes may be set as standard eyebrow make-up, and the eyebrow make-up reference data of eyebrow make-up other than the standard eyebrow make-up may include feature information different from the standard eyebrow make-up, and the electronic device may execute eyebrow make-up on the user's facial image according to the feature information.

The plurality of standard person images may include ten eyebrow make-up shapes according to the Sibmiyo, wherein the eyebrow make-up reference data includes a reference eyebrow length and a reference eyebrow height for each of the ten eyebrow make-up shapes, and when the user's eye length and pupil size are different from those of the selected standard person image, the electronic device allows the user's eyebrow length and eyebrow height to be larger or smaller than a reference eyebrow length and a reference eyebrow height of the standard person image so as to perform virtual eyebrow make-up to the user's eyebrows.

One of the ten eyebrow make-up shapes may be set as a standard eyebrow make-up, and the eyebrow make-up reference data of eyebrow make-up other than the standard eyebrow make-up may include feature information different from the standard eyebrow make-up, wherein the electronic device executes eyebrow make-up on the user's facial image according to the feature information.

When the eye length and the pupil size are larger than the reference eye length and reference pupil size of the selected standard person image, the electronic device may apply eyebrow make-up to the user's facial image by making the user's eyebrow length and eyebrow height smaller than the reference eyebrow length, and larger than the reference eyebrow height, respectively.

When the eye length and the pupil size are smaller than the reference eye length and reference pupil size of the selected standard person image, the electronic device may apply eyebrow make-up to the user's facial image by making the user's eyebrow length and eyebrow height smaller than the reference eyebrow length, and smaller than the reference eyebrow height, respectively.

When the eye length is larger than the reference eye length of the selected standard person image, and the pupil size is smaller than the reference pupil size of the selected standard person image, the electronic device may apply eyebrow make-up to the user's facial image by making the user's eyebrow length and eyebrow height larger than the reference eyebrow length, and smaller than the reference eyebrow height, respectively.

When the eye length is smaller than the reference eye length of the selected standard person image, and the pupil size is larger than the reference pupil size of the selected standard person image, the electronic device may apply eyebrow make-up to the user's facial image by making the user's eyebrow length and eyebrow height larger than the reference eyebrow length, and larger than the reference eyebrow height, respectively.

A method for providing a traditional make-up service according to an embodiment of the present disclosure may provide a user with traditional make-up of a standard person similar to the user's face, thereby providing traditional make-up-related information online.

The effects herein are not limited to the above-mentioned effects, and other effects that are not mentioned herein will be clearly understood by those skilled in the art from the description below.

### BRIEF DESCRIPTION OF THE DRAWINGS

FIG. 1 shows an example of a standard person image with traditional make-up.

FIG. 2 visualizes ten eyebrow shapes listed in the Gyuhap Chongseo.

FIG. 3 shows an example of a face capture frame displayed on an electronic device.

FIG. 4 is a diagram for explaining an eyebrow size and

eye size of gaewoneoae-mi.

FIG. 5 is a diagram for explaining standard eyebrow make-up.

FIG. 6 shows an example of a configuration of an electronic device.

### DETAILED DESCRIPTION OF THE PREFERRED EMBODIMENT

Hereinafter, an embodiment of the present disclosure will be described in detail with reference to the accompanying drawings. However, it will be readily apparent to those skilled in the art that the accompanying drawings are merely provided to more easily disclose the description of the present disclosure, and the scope of the present disclosure is not limited to the scope of the accompanying drawings.

Additionally, it should be noted that terms used herein are merely used to describe specific embodiments, but not to limit the present disclosure. A singular representation may include a plural representation, unless the context clearly indicates otherwise.

Terms “include” or “have” used herein should be understood that they are intended to indicate the existence of a feature, a number, a step, an element, a component or a combination thereof disclosed in the specification, and it may also be understood that the existence or additional possibility of one or more other features, numbers, steps, constituent elements, components or combinations thereof are not excluded in advance.

Next, a method for providing a traditional make-up service according to an embodiment of the present disclosure will be described with reference to the drawings.

A method for providing a traditional make-up service according to an embodiment of the present disclosure includes displaying, by an electronic device 101, a plurality of standard person images with traditional make-up.

The electronic device 101 or an electronic device 104 that can communicate with the electronic device 101 may be a desktop computer, a laptop computer, a smart phone, a server computer, a wearable device (e.g., a smart watch, smart glasses), a head mounted display (HMD), a home appliance with a built-in computing device, or the like, but the present disclosure is not limited thereto.

Traditional make-up may include make-up methods, cosmetic materials, and accessories (e.g., a gache, a hair braiding style, and a hair ornament) used by women during the Joseon Dynasty.

The make-up method may be based on or reinterpreted from the Sibmiyo and the Jeomsunmyeong from the Gyuhap Chongseo of the Joseon Dynasty. The Sibmiyo is a recitation of ten eyebrow shapes, comparing the shapes of eyebrows and foreheads to mandarin ducks, small mountains, three peaks, and pearls. The Jeomsunmyeong is a list of sixteen names describing the shape and concentration of lip rouge.

The levels of traditional make-up include damjang, nongjang, yeomjang, and ungjang. The damjang refers to a subtle state of trimming the skin, while the nongjang refers to a degree to which color is added. The yeomjang refers to make-up with dark and alluring colors, and the ungjang refers to make-up used during ceremonies such as weddings. The damjang, nongjang, yeomjang and ungjang may follow the methods that remain on the record or may be modern reinterpretations.

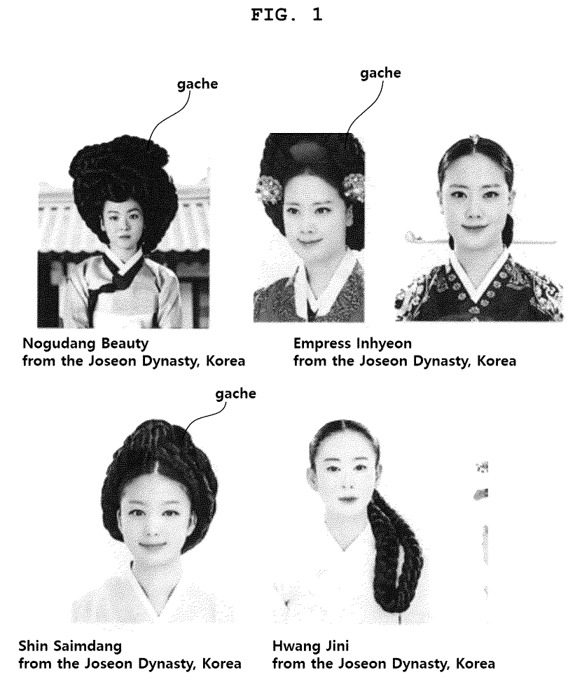

A standard person image may be a portrait of a woman from the Joseon Dynasty or a photo of a standard person with traditional make-up according to a portrait of a woman from the Joseon Dynasty. That is, the standard person image may be that of a model or actress with traditional make-up, similar to a woman in a portrait from the Joseon Dynasty. For example, as shown in FIG. 1, a standard person image may be an image of a model or actress with make-up similar to the portraits of the Nogudang Beauty, Empress Inhyeon, Shin Saimdang, and Hwang Jini from the Joseon Dynasty.

A method for providing a traditional make-up service according to an embodiment of the present disclosure includes displaying, by an electronic device 101, a user's facial image. The electronic device 101 may display the user's facial image captured through a built-in camera, or may display the user's facial image transmitted from an external source in a wired or wireless manner.

A method for providing a traditional make-up service according to an embodiment of the present disclosure includes displaying, by the electronic device 101, a standard person image having a high correlation with a result of analyzing the user's facial image among a plurality of standard person images based on an analysis of the user's facial image.

The electronic device 101 may perform an analysis of the user's facial image and a derivation of a standard person image with a high correlation, and may also receive a result of analyzing the user's facial image and deriving a standard person image with a high correlation from the other electronic device 104 that can communicate with the electronic device 101.

The analysis of the standard person image and the user's facial image may include the analysis of facial contour, facial component area (e.g., head, pupils, eyelids, cheekbones, cheeks, eyebrows, nose, lips, etc.), and skin color tone. The facial contour and facial composition area of a standard person and user can be derived using an edge detecting technology, but the present disclosure is not limited thereto.

The facial contour and facial component area may be detected by using edge detection by deep learning. In the present disclosure, deep learning may be performed through a deep learning program such as Keras, Apache MXNnet, Deeplearning4j, Tensorflow, Microsoft Cognitive Toolkit, or Theano, but the present disclosure is not limited thereto.

The skin color tone of the standard person and user may be derived through a skin color extraction algorithm such as a peer algorithm, an NNYUV algorithm, an NNHSV algorithm, a LutYUV algorithm, and a Kismet algorithm.

The correlation may be a degree of correlation of facial contour and skin color tone between the standard person and the user. Accordingly, the electronic device 101 may display a standard person image having the highest correlation with the user's facial contour and skin color tone.

In selecting a standard person image, a weight may be set for the user's facial contour and skin color tone. For example, when facial contour is more important than skin color tone in selecting a standard person image, a weight for facial contour may be greater than that for skin color tone. Likewise, the weight can be changed according to the setting.

A method for providing a traditional make-up service according to an embodiment of the present disclosure includes displaying, by the electronic device 101, a user's facial image with virtual make-up by user-customized make-up data according to make-up reference data of a standard person image having a high correlation with the user's facial image and a result of analyzing the user's facial image.

For each standard person image, make-up reference data and facial reference data may be matched and stored in the memory of the electronic device 101 or the memory of the other electronic device 104 that can communicate with the electronic device 101.

The make-up reference data may include color reference information required for make-up of a standard person image and recipe information on the ingredients and ingredient ratio of natural materials according to the color reference information.

In this case, the color reference information may include concentration information on lip rouge according to the Jeomsunmyeong described above. Additionally, the color reference information may include information on a degree of color addition according to the nongjang described above.

Besides, the color reference information may include numerical information on a degree of skin softness according to the previously described damjang. The color reference information may include color information for applying dark color make-up according to the previously described yeomjang. Additionally, the color reference information may include color information for ceremonial make-up according to the ungjang.

In order to digitize traditional Jeomsunmyeong, nongjang, damjang, yeomjang and ungjang, those make-up methods may be reinterpreted to set a concentration level of lip rouge, a degree of color addition, and a color composition for color make-up or ceremonial make-up.

The make-up reference data may recipe include information on the ingredients and ingredient ratio of natural materials required for make-up for each facial component area of a standard person image.

The facial reference data may include information on the facial contour of a standard person, information on the facial component area of the standard person, a gache worn by the standard person, a hair braiding style of the standard person, information on a hair ornament (e.g., a hairpin, a hair band, a Dduljam decoration, etc.) of the standard person, a size ratio between a face of the standard person and the gache, a size ratio between the face of the standard person and the hair ornament, and the like, but the present disclosure is not limited thereto.

The electronic device 101 or the other electronic device 104 communicating with the electronic device 101 may perform virtual make-up by executing a virtual make-up algorithm to perform a color overlay on the user's facial image according to the make-up reference data and facial reference data of the selected standard person image.

The virtual make-up algorithm may perform a color overlay on the user's facial component area based on color reference information corresponding to the facial component area of the selected standard person.

The virtual make-up algorithm may derive user-customized color information by adjusting the color reference information of a standard person according to the user's skin color tone as described above, and perform virtual make-up tailored to the user according to the user-customized color information.

In this case, user-customized color information may be included in the user-customized make-up data. Additionally, recipe information of user-customized cosmetic materials may be derived based on user-customized color information, and user-customized make-up data may include the recipe information of user-customized cosmetic materials.

The recipe information of user-customized cosmetic materials corresponds to a result of adding or reducing at least some of the ingredients of the make-up reference data based on a result of analyzing the user's facial image.

The electronic device 101 or the other electronic device 104 that can communicate with the electronic device 101 may derive the user's skin color tone through analyzing the user's facial image. The electronic device 101 or the other electronic device 104 that can communicate with the electronic device 101 may derive the user's personal color based on the user's skin color tone.

As described above, a standard person image having a high correlation with the user's facial image may be selected, and make-up reference data of the selected standard person image may be selected.

The make-up reference data may include information on a recipe of natural materials used in the make-up of the selected standard person image. Even when the selected standard person image is highly correlated with the user's facial image, it may not match the skin color tone of the user's face.

The electronic device 101 or the other electronic device 104 that can communicate with the electronic device 101 may derive the user's skin color tone, and add or reduce at least some of the ingredients of the make-up reference data according to the skin color tone so as to provide recipe information on the ingredients and ingredient ratio of natural materials suitable for the user.

That is, the result of analyzing the user's facial image may include a skin color tone, and a recipe of user-customized cosmetic materials may add or reduce at least some of the ingredients of the cosmetic reference data according to the user's skin color tone.

The electronic device 101 may display information on selling and delivering cosmetics according to the recipe of the user-customized cosmetic materials. The user may check the user's facial image with virtual make-up through the electronic device 101. The virtual make-up may be carried out according to the recipe of the user-customized cosmetic materials.

If the user likes the virtual make-up, he or she may purchase cosmetics according to the recipe of the user-customized cosmetic materials. The electronic device 101 or the other electronic device 104 that can communicate with the electronic device 101 may store and display information required for the sale and delivery of the cosmetics.

The information required for the sale and delivery of the cosmetics includes the price, capacity, features, payment information, delivery information input fields (e.g., address, delivery precautions, etc.) of the cosmetics, and information on the main natural materials of the cosmetics, but the present disclosure is not limited thereto.

The analysis of the user's facial image includes the user's facial contour, and the facial reference data of each of the plurality of standard person images may include a facial contour, a gache, and a hair ornament of each standard person.

The electronic device 101 may display the gache and hair ornament included in the facial reference data of a standard person image having a high correlation with the user's facial contour by adding to the user's facial image.

That is, as described above, the facial reference data may include not only information on the facial contour of a standard person, but also information on the gache, hair braiding style, and hair ornament worn by the standard person.

In order to derive a correlation between the user's facial image and the standard person image, the electronic device 101 or the other electronic device 104 that can communicate with the electronic device 101 may derive a correlation between the facial contour of the standard person and the user's facial contour. A correlation between the facial contour of the standard person and the user's facial contour may be with respect to a shape of the facial contour or with respect to a size with the facial contour.

When a standard person similar to the user's facial contour is selected, the gache and hair ornament worn by the standard person may be overlaid and virtually worn on the user's facial image.

The electronic device 101 may adjust and display a size of the gache included in the facial reference data according to the user's facial size.

As described above, the facial reference data may include not only information on the facial contour of a standard person, but also information on the gache worn by the standard person and information on a size ratio between the face and the gache.

Since the user's facial size and the standard person's facial size may be different, when the standard person's facial size is applied to the user's face as it is, a size of the gache may not fit the user's face.

The electronic device 101 or the other electronic device 104 communicating with the electronic device 101 may adjust a size of the gache to fit the user's facial size through information on a size ratio between the face and the gache of the standard person.

A method for providing a traditional make-up service according to another embodiment of the present disclosure relates to traditional make-up for eyebrows, and includes displaying, by the electronic device 101, a plurality of standard person images with traditional make-up for eyebrows.

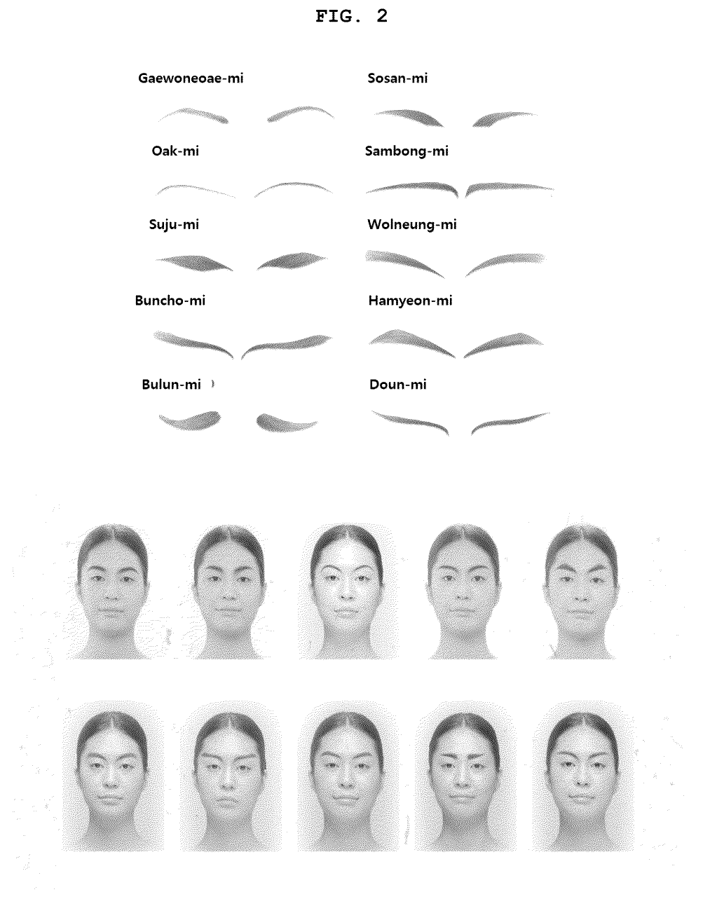

The plurality of standard person images may include ten eyebrow make-up shapes according to the Sibmiyo described above. An upper part of FIG. 2 visualizes the ten eyebrow shapes listed in the Gyuhap Chongseo, and a lower part of FIG. 2 shows a standard person image with the ten eyebrow shapes.

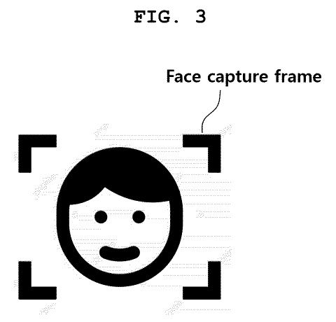

A method for providing a traditional make-up service according to another embodiment of the present disclosure includes displaying, by an electronic device 101, a user's facial image. The electronic device 101 may display a face capture frame as shown in FIG. 3 to compare the user's facial size with the facial size of the standard person. When the user's face is outside the face capture frame, the user's facial image may appear excessively large, making it difficult to compare it to the facial size of the standard person.

A method for providing a traditional make-up service according to another embodiment of the present disclosure includes selecting and displaying, by the electronic device 101, a standard person image having an eyebrow shape highly correlated with the user's eyebrow shape from among a plurality of standard person images based on an analysis of eyebrows on the user's facial image.

As described above, a facial component area such as eyebrows and eyes may be detected from the standard person image and the user's facial image. The electronic device 101 may select a standard person image having an eyebrow shape most similar to the detected user's eyebrow area. Accordingly, an eyebrow shape corresponding to the user's eyebrows may be selected from among the ten eyebrow shapes of the Sibmiyo.

A method for providing a traditional make-up service according to another embodiment of the present disclosure includes adjusting, by the electronic device 101, the eyebrow make-up reference data of the standard person image having a high correlation according to an eye size of the user's facial image to apply the data to eyebrow make-up on the user's facial image.

The eye size may have a big impact on eyebrow make-up. That is, even if the standard person and the user have the same Sibmiyo eyebrow shape, when the eye sizes of the standard person and the user are different, the user's eyebrow make-up may be different from that of the standard person.

Accordingly, the electronic device 101 may adjust the eyebrow make-up reference data of the standard person image according to the user's eye size.

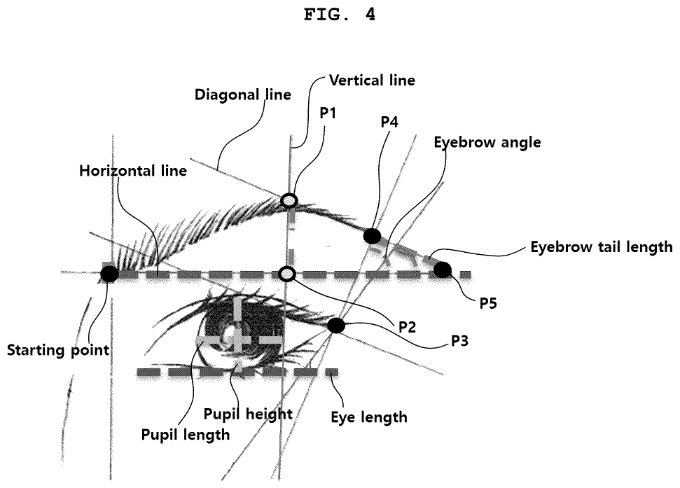

The eyebrow make-up reference data may include a reference eyebrow length, a reference eyebrow height, and a reference eyebrow tail length for each of the ten eyebrow make-up shapes. This is to explain the reference eyebrow length, reference eyebrow height, and reference eyebrow tail length using the gewoneoae-mi shown in FIG. 4 as an example.

As shown in FIG. 4, the reference eyebrow length may be a length to an intersection point P5 of a horizontal line passing through a starting point of the eyebrow and a diagonal line passing through the eyebrow tail. The eyebrow height may correspond to a length between an intersection point P1 where a vertical line meets a part of the diagonal line that overlaps the eyebrow tail and an intersection point P2 where the vertical line meets the horizontal line. The eyebrow length, eyebrow height, and eyebrow tail length of the user's facial image may also be measured in the same way.

The electronic device 101 may adjust the reference eyebrow length, reference eyebrow height, and reference eyebrow tail length of a standard person image selected according to the user's eye length and pupil size.

For example, when the user's eye length and pupil size are different from those of the selected standard person image, the electronic device 101 may allow the user's eyebrow length and eyebrow height to be larger or smaller than a reference eyebrow length and a reference eyebrow height of the standard person image so as to perform virtual eyebrow make-up in a gaewoneoae-mi shape to the user's eyebrows.

In FIG. 4, an eyebrow angle may be an angle formed by the diagonal line and an additional diagonal line passing through an end P3 of the eye and an end P4 of the eyebrow tail with the horizontal line.

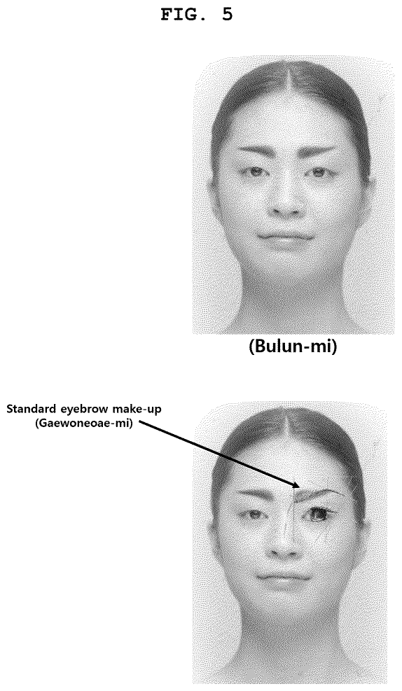

As shown in FIG. 5, in the case of a bulun-mi, since there is almost no eyebrow tail, it may be difficult to define it using the reference eyebrow length, reference eyebrow height, and reference eyebrow tail length described above.

One of the ten eyebrow make-up shapes may be set as a standard eyebrow make-up (e.g., gaewoneoae-mi), and the bulun-mi may be defined by a reference eyebrow length, a reference eyebrow height, and a reference eyebrow tail length by comparing it with the standard eyebrow make-up.

That is, as shown at a bottom in FIG. 5, a starting position of the eyebrow is the same and a gaewoneoae-mi is overlapped with a bulun-mi, wherein a virtual eyebrow tail length of the bulun-mi may be set according to an eyebrow tail length of the overlapping gewoneoae-mi, and the bulun-mi may also derive a reference eyebrow length, a reference eyebrow height, and a reference eyebrow tail length (corresponding to the virtual eyebrow tail length) using a horizontal line, a diagonal line, a vertical line, or the like of the gaewoneoae-mi described above.

Additionally, feature information on the bulun-mi compared to the standard eyebrow make-up may be stored. That is, the eyebrow make-up reference data of eyebrow make-up (e.g., bulun-mi) other than standard eyebrow make-up (e.g., gaewoneoae-mi) may include feature information different from the standard eyebrow make-up.

For example, as shown at a bottom in FIG. 5, in the case of the bulun-mi, a front part of the eyebrow is thicker than that of the gaewoneoae-mi, and there is no eyebrow tail. As described above, the bulun-mi is defined by a horizontal line, a vertical line, and a diagonal line used in the gaewoneoae-mi.

Accordingly, a front part of the eyebrow of the bulun-mi may be set from a starting position of the eyebrow in FIG. 4 to point P1. The eyebrow make-up reference data of the bulun-mi may include feature information that a make-up thickness of the eyebrow from a starting position of the eyebrow to point P1 is thicker than that of gaewoneoae-mi.

Additionally, the eyebrow make-up reference data of the bulun-mi may include feature information that no make-up is applied to a part corresponding to the virtual eyebrow tail length.

In the above, a front part of the eyebrow of the bulun-mi is set to P1, but may be set to the previous position depending on the design. Additionally, a degree to which a front part of the eyebrow of the bulun-mi is thicker than that of the gaewoneoae-mi may also be determined by a position of the front part of the eyebrow of the bulun-mi.

The electronic device 101 may perform eyebrow make-up on the user's facial image based on such feature information.

As described above, the eye length and pupil size may affect eyebrow make-up. Accordingly, an eyebrow length, an eyebrow height, and an eyebrow tail length may be adjusted to fit the user's eye length and pupil size.

For example, when the user's eye length and pupil size are larger than a reference eye length and a reference pupil size of the selected standard person image, the electronic device 101 may apply eyebrow make-up to the user's facial image by making the user's eyebrow length, eyebrow height, and eyebrow tail length smaller than the reference eyebrow length, larger than the reference eyebrow height, and larger than the reference eyebrow tail length, respectively.

When the eye length and pupil size are smaller than a reference eye length and a reference pupil size of the selected standard person image, the electronic device 101 may apply eyebrow make-up to the user's facial image by making the user's eyebrow length, eyebrow height, and eyebrow tail length smaller than the reference eyebrow length, smaller than the reference eyebrow height, and larger than the reference eyebrow tail length, respectively.

When the eye length is larger than a reference eye length of the selected standard person image and the pupil size is smaller than a reference pupil size of the selected standard person image, the electronic device 101 may apply eyebrow make-up to the user's facial image by making the user's eyebrow length, eyebrow height, and eyebrow tail length larger than the reference eyebrow length, smaller than the reference eyebrow height, and larger than the reference eyebrow tail length, respectively.

When the eye length is smaller than a reference eye length of the selected standard person image and the pupil size is larger than a reference pupil size of the selected standard person image, the electronic device 101 may apply eyebrow make-up to the user's facial image by making the user's eyebrow length, eyebrow height, and eyebrow tail length larger than the reference eyebrow length, larger than the reference eyebrow height, and larger than the reference eyebrow tail length, respectively.

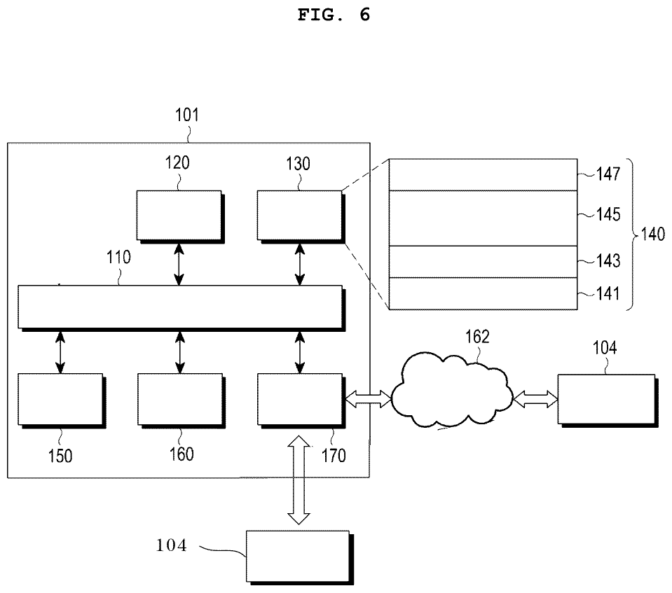

Next, the structure of the electronic device 101 shown in FIG. 6 will be described.

The electronic device 101 may include a processor 120, a memory 130, a bus 110, an input/output interface 150, a display 160, and a communication interface 170. In some embodiments, the electronic device 101 may additionally include fewer or other elements than the elements.

The bus 110 may include, for example, a circuit that connects the elements to one another and transmits communication (e.g., control messages and/or data) between the elements.

The processor 120 may include at least one of a micro controller unit (MCU), a central processing unit (CPU), and an application processor (AP), and further include one or more of a communication processor (CP), a graphics processing unit (GPU), a neural processing unit (NPU), and a data processing unit (DPU). The processor 120 may, for example, execute calculation or data processing related to control and/or communication of at least one other element of the electronic device 101.

The memory 130 may include a non-volatile memory. For example, the non-volatile memory may include at least one of a read only memory (ROM), a hard disk drive (HDD), an optical disk drive (ODD), a solid state drive (SSD), and a flash memory, but is not limited thereto.

The memory 130 may store, for example, at least one of a command, a logic, a file, and data related to at least one other element of the electronic device 101. According to one embodiment, the memory 130 may store software and/or a program 140.

In addition to the memory 130, the provision device of the present disclosure may include a volatile memory such as a RAM.

Although the drawing shows that the memory 130 communicates with the processor 120 through the bus 110, the present disclosure is not limited thereto. For example, the processor 120 may receive and process at least one of a command, a logic, and data by accessing the memory 130 located externally or remotely through a network 162, the communication interface 170, or the input/output interface 150. Additionally, the processor 120 may receive and execute the software and/or the program 140 from memory 130 located externally or remotely.

The program 140 may include, for example, a kernel 141, middleware 143, an application programming interface (API) 145, and/or an application program (or “application”) 147. At least part of the kernel 141, middleware 143, or API 145 may be called an operating system (OS).

The kernel 141 may control or manage system resources (e.g., the bus 110, the processor 120, the memory 130 or the like) used to execute an operation or function implemented in other programs (e.g., the middleware 143, the API 145, or the application program 147). Additionally, the kernel 141 may provide an interface that can control or manage system resources by accessing individual elements of the electronic device 101 from the middleware 143, the API 145, or the application program 147.

The middleware 143 may, for example, serve as an intermediary such that the API 145 or the application program 147 can communicate with the kernel 141 to exchange data. In addition, the middleware 143 may perform, in relation to job requests received from the application program (147), control (e.g., scheduling or load balancing) on a job request, for example, by using a method such as assigning a priority for using the system resources (e.g., the bus 110, the processor 120, or the memory 130) of the electronic device 101 to at least one application among the application programs 147.

The API 145, which is, for example, an interface for the application 147 to control a function provided by the kernel 141 or middleware 143, may include, for example, at least one interface or function (e.g., instruction) for file control, window control, image processing, or character control.

The input/output interface 150 may serve as an interface that can transmit, for example, commands or data input from a user or other external device to other element(s) of the electronic device 101. Additionally, the input/output interface 150 may output commands or data received from other elements(s) of the electronic device 101 to a user or other external device. For example, the input/output interface 150 may be a serial port, a parallel port, a PS/2, an apple desktop bus (ADB), a small computer system interface (SCSI), a USB, a HDMI, a DVI-I, or a thunderbolt, but is not limited thereto.

The display 160 may include, for example, at least one of a liquid crystal display (LCD), a light emitting diode (LED) display, an organic light emitting diode (OLED) display, a microelectromechanical systems (MEMS) display, an electronic paper display, and a beam projector. The display 160 may, for example, display various content items (e.g., text, images, videos, icons, or symbols) to the user. The display 160 may include a touch screen, and may receive a touch, a gesture, a proximity, or a hovering input using, for example, an electronic pen or a part of the user's body.

The communication interface 170 may establish communication between, for example, the electronic device 101 and the external electronic device 104. For example, the communication interface 170 may be connected to the network 162 via wireless communication or wired communication to communicate with the external electronic device 104.

The wireless communication or wired communication may be, for example, at least one of Bluetooth communication, NFC communication, Zigbee communication, Wi-Fi communication, cellular communication, and wired LAN, but is not limited thereto. The cellular communication may use at least one of LTE, LTE-A, CDMA, WCDMA, UMTS, WiBro, GSM and IMT-2020, but is not limited thereto.

The network 162 may include at least one of a LAN, a WAN, the Internet, an intranet, a telephone network, a mobile communication network, and a blockchain, but is not limited thereto.

The structure of the electronic device 101 has been described above as an example, but the structure of the electronic device 104 may also be similar to that of the electronic device 101.

As described above, embodiments according to the present disclosure have been examined, and it will be apparent to those skilled in the art that the present disclosure can be embodied in other specific forms without departing from the concept or scope thereof, in addition to the above-described embodiments. Therefore, the foregoing embodiments must be considered as illustrative rather than restrictive, and accordingly, the present disclosure is not limited to the foregoing description but may be modified within the scope of the appended claims and their equivalents.

### DESCRIPTION OF SYMBOLS

Electronic device 101
Another electronic device 104

What is claimed is:

1. A method for providing a traditional make-up service, the method comprising:
displaying, by an electronic device, a plurality of standard person images with traditional make-up;
displaying, by the electronic device, a user's facial image;
displaying, by the electronic device, a standard person image having a high correlation with a result of analyzing the user's facial image among the plurality of standard person images based on the analysis of the user's facial image; and
displaying, by the electronic device, the user's facial image with virtual make-up by user-customized make-up data based on the make-up reference data of the standard person image having the high correlation and the result of analyzing the user's facial image.

2. The method of claim 1, wherein the user-customized make-up data comprises recipe information of user-customized cosmetic materials.

3. The method of claim 2, wherein the recipe information of the user-customized cosmetic materials corresponds to a result of adding or reducing at least some of the ingredients of the make-up reference data based on the result of analyzing the user's facial image.

4. The method of claim 3, wherein the result of analyzing the user's facial image comprises a skin color tone, and
wherein the recipe of the user-customized cosmetic materials adds or reduces at least some of the ingredients of the make-up reference data according to the user's skin color tone.

5. The method of claim 3, wherein the electronic device displays information on selling and delivering cosmetics according to a recipe of the user-customized cosmetic materials.

6. The method of claim 1, wherein the analysis of the user's facial image comprises the user's facial contour,
wherein the facial reference data of each of the plurality of standard person images comprises a facial contour, a gache, and a hair ornament of each standard person, and
wherein the electronic device displays the gache and hair ornament included in the facial reference data of a standard person image having a high correlation with the user's facial contour by adding to the user's facial image.

7. The method of claim 6, wherein the electronic device adjusts and displays a size of the gache included in the facial reference data according to the user's facial size.

8. The method of claim 1, wherein the standard person image is a portrait of a woman from the Joseon Dynasty or a photo of a standard person with traditional make-up according to the portrait of the woman from the Joseon Dynasty.

9. A method for providing a traditional make-up service, the method comprising:
displaying, by an electronic device, a plurality of standard person images with traditional make-up for eyebrows;
displaying, by the electronic device, a user's facial image;
selecting and displaying, by the electronic device, a standard person image having an eyebrow shape highly correlated with the user's eyebrow shape from among a plurality of standard person images according to an analysis of eyebrows on the user's facial image; and
adjusting, by the electronic device, the eyebrow make-up reference data of the standard person image having a high correlation according to an eye size of the user's facial image to apply the data to eyebrow make-up on the user's facial image.

10. The method of claim 9, wherein the plurality of standard person images comprise ten eyebrow make-up shapes according to the Sibmiyo,
wherein the eyebrow make-up reference data comprises a reference eyebrow length and a reference eyebrow height for each of the ten eyebrow make-up shapes, and
wherein when the user's eye length and pupil size are different from those of the selected standard person image, the electronic device allows the user's eyebrow length and eyebrow height to be larger or smaller than a reference eyebrow length and a reference eyebrow height of the standard person image so as to perform virtual eyebrow make-up to the user's eyebrows.

11. The method of claim 10, wherein one of the ten eyebrow make-up shapes is set as a standard eyebrow make-up,
wherein the eyebrow make-up reference data of eyebrow make-up other than the standard eyebrow make-up comprises feature information different from the standard eyebrow make-up, and
wherein the electronic device executes eyebrow make-up on the user's facial image according to the feature information.

12. The method of claim 10, wherein when the eye length and the pupil size are larger than the reference eye length and reference pupil size of the selected standard person image,
the electronic device applies eyebrow make-up to the user's facial image by making the user's eyebrow length and eyebrow height smaller than the reference eyebrow length, and larger than the reference eyebrow height, respectively.

13. The method of claim 12, wherein when the eye length and the pupil size are smaller than the reference eye length and reference pupil size of the selected standard person image,
the electronic device applies eyebrow make-up to the user's facial image by making the user's eyebrow length and eyebrow height smaller than the reference eyebrow length, and smaller than the reference eyebrow height, respectively.

14. The method of claim 12, wherein when the eye length is larger than the reference eye length of the selected standard person image, and the pupil size is smaller than the reference pupil size of the selected standard person image,
the electronic device applies eyebrow make-up to the user's facial image by making the user's eyebrow length and eyebrow height larger than the reference eyebrow length, and smaller than the reference eyebrow height, respectively.

15. The method of claim 12, wherein when the eye length is smaller than the reference eye length of the selected standard person image, and the pupil size is larger than the reference pupil size of the selected standard person image,
the electronic device applies eyebrow make-up to the user's facial image by making the user's eyebrow length and eyebrow height larger than the reference eyebrow length, and larger than the reference eyebrow height, respectively.
